(19) United States
(12) Patent Application Publication
(10) Pub. No.: US 2011/0280520 A1
(43) Pub. Date: Nov. 17, 2011

(54) OPTICAL CONNECTOR

(75) Inventor: Akihiro Shimotsu, Kanagawa (JP)

(73) Assignee: MOLEX INCORPORATED, Lisle, IL (US)

(21) Appl. No.: 13/146,284

(22) PCT Filed: Jan. 29, 2010
(86) PCT No.: PCT/US10/22545

§ 371 Date: Jul. 26, 2011

(30) Foreign Application Priority Data
Jan. 29, 2009 (JP) 2009-017877

(51) Int. Cl. G02B 6/36

(52) U.S. Cl. 385/76

(57) ABSTRACT

An optical connector is disclosed. The optical connector comprises a connector housing, configured to mount thereon a plug which is connected to a cable having therein an optical waveguide, and a lock member, attached to the connector housing in an attitude-changeable state and configured to be capable of locking the plug. The connector housing is provided with an abutting portion, configured to engage a front portion of the plug. The lock member is provided with a detection portion, having at least a portion thereof being positioned in the abutting portion when the lock member is at an open position thereof. When the front portion is engaged with the abutting portion, at least a portion of the plug is brought into tight contact with the detection portion, allowing the lock member to start an attitude changing operation.

### REFERENCE TO RELATED APPLICATIONS

The Present Application claims priority of Japanese Patent Application No. 2009-017877, entitled “Optical Connector,” and filed 29 Jan. 2009, the contents of which is fully incorporated in its entirety herein.

### BACKGROUND OF THE PRESENT APPLICATION

The Present invention relates generally to an optical connector.

In an electronic device or apparatus, in order to decrease the overall size of a casing and increase in the size of a display screen, the casing may be configured to be collapsible. In such a case, a flexible printed circuit and conductive wires such as a fine coaxial cable are arranged so as to pass through an inside of a hinge portion that allows one casing to be pivotably connected with another casing so that signals can be transmitted through parallel transmission.

Although it is preferred that signal transmission speed be increased in response to an increase in image resolution, since there is a limit in increasing the inside dimension of the hinge portion, it is practically impossible to arrange a conductive wire having a large width or diameter thereof. In addition, when a countermeasure against electro magnetic interference (EMI) is utilized, the conductive wire will become larger in the width or diameter thereof.

Thus, a method of optical transmission has been developed, capable of transmitting a large amount of signals through transmission and being an excellent EMI countermeasure. An example of such a method is disclosed in Japanese Patent Application No. 11-84174, the contents of which are hereby incorporated herein in its entirety.

Additionally, FIG. 8 illustrates a perspective view of a conventional optical connector. In FIG. 8, optical element portion 870 is configured to receive therein an optical module including a light emitting element, a light receiving element and the like, and is coupled to connector housing 811 by means of coupling member 841. Connector housing 811 is provided with groove-shaped guide portion 814, configured to allow a non-illustrated plug connected to a front end of a non-illustrated optical fiber to be inserted therein, and engagement wall portion 818 configured to be engaged with a front end of the plug. In addition, guide projections 831 are formed on a wall surface of engagement wall portion 818, and are engaged with a pair of engagement holes formed in the plug, so that the plug is placed in position after insertion thereof.

The optical connector is provided with clamping member 821, rotatably attached to connector housing 811. A front end of clamping member 821 is rotatably mounted on rotation shaft 813, configured to project from a side surface of engagement wall portion 818. Clamping member 821 is provided with elongated plate-like arm parts 822, configured to extend rearward from the front end of clamping member 821. Moreover, latching portions 827 are connected to rear ends of arm parts 822 so as to engage with the rear end of the plug, and operation portion 825 allowing an operator to operate is connected to the rear ends of latching portions 827.

When the plug is connected to the optical connector, clamping member 821 is rotated from an attitude shown in FIG. 8 to raise operation portion 825, so that an upper surface of guide portion 814 is open. Subsequently, the plug is inserted into guide portion 814 from a rear side thereof, so that a front end surface of the plug comes into tight contact with the wall surface of engagement wall portion 818. In this case, the positioning of the plug is carried out by tightly fitting guide projections 831, engaging the engagement holes of the plug. Finally, when clamping member 821 is rotated to lower operation portion 825, the optical connector returns to assume the attitude shown in FIG. 8. Owing to this configuration, latching portions 827 are engaged with the rear end of the plug, and the plug is connected to the optical connector.

However, in conventional optical connectors, since the positioning of the plug is carried out by tightly fitting guide projections 831 within the engagement holes of the plug, it may be difficult to perform a connecting operation. Usually, when a plug connected to an optical fiber is connected to an optical connector, guide projections 831 and the engagement holes are designed to have an extremely small dimensional tolerance since the positioning of a plug-side optical path relative to a connector-side optical path requires an extremely high degree of precision. For this reason, an operator moving the plug to cause guide projections 831 to be inserted into the engagement holes requires a high degree of accuracy and is thus difficult to perform.

Moreover, when an unnecessarily large force is applied to the guide portion, guide projections 831 may break. In recent years, with the advance in the miniaturization of the optical connector, guide projections 831 too have become miniaturized. For this reason, when an operator changes the attitude or the direction of the plug, for example, when guide projections 831 engage the engagement holes of the plug, guide projections 831 may be broken by a force.

Furthermore, before operation portion 825 is lowered to rotate clamping member 821, it is necessary to confirm that guide projections 831 are tightly engaged, by fitting, with the engagement holes of the plug so that the positioning of the fitting plug is completed. However, because the respective members, including guide projections 831 and the engagement holes of the plug, are very small, it is difficult to visually recognize the positioning of the fitting plug.

### SUMMARY OF THE PRESENT APPLICATION

Therefore, it is an object of the Present Application to obviate the above-described problems encountered by the conventional optical connector and to provide an optical connector having such a configuration that a lock member is formed with a detection portion which is capable of detecting a plug, and when the position of a front portion of the plug connected to an optical waveguide relative to an abutting portion of a connector housing is determined, the lock member is allowed to start an attitude changing operation thereof, whereby it is not only possible to perform the positioning of the plug relative to the connector housing in an easy and accurate manner but also to recognize the completion of the positioning of the plug in an easy manner. Accordingly, the optical connector is able to realize high durability and good operability and to enable manufacture thereof with a small size at a low cost and in a simple structure.

In accordance with the Present Application, an optical connector is provided, including: A connector housing configured to mount on a plug, connected to a cable having an optical waveguide; and a lock member attached to the connector housing in an attitude-changeable state and configured to lock the plug, wherein: the connector housing is provided with an abutting portion configured to engage a front portion of the plug; the lock member is provided with a detection portion having at least a portion thereof positioned in the abutting portion when the lock member is at an open position; and when the front portion is engaged with the abutting portion, at least a portion of the plug is in tight contact with the detection portion, allowing the lock member to start an attitude changing operation from the open position.

In accordance with another embodiment of the Present Application, the optical connector is configured so that the plug is mounted on the connector housing so that a lower surface thereof opposes an upper surface, and the lock member is provided with a plug pressing portion capable of pressing an upper surface of the plug toward an upper surface of the connector housing.

In accordance with a further embodiment of the Present Application, the optical connector is configured so that the lock member continues the attitude changing operation toward a closed position by its own weight after the attitude changing operation is started.

In accordance with a still further embodiment of the Present Application, the optical connector is configured so that the detection portion has at least a portion which is exposed from the abutting portion when the lock member is at the open position.

In accordance with a still further embodiment of the Present Application, the optical connector is configured so that the lock member is provided with an adjustable portion provided with a bent portion; a latched portion engaged with or disengaged from the connector housing by the adjustable portion; and a pressing portion configured to be capable of pressing the plug toward the abutting portion in response to the contraction of the adjustable portion.

In accordance with a still further embodiment of the Present Application, the optical connector is configured so that either of the front portion or the abutting portion is formed with a convex portion, provided with a circular arc-shaped end portion; that the other one of the front portion and the abutting portion is formed with a concave portion, provided with two oblique side portions being inclined in mutually opposite directions; and that when the front portion and the abutting portion are engaged with each other, at least a portion of the convex portion is inserted into the concave portion, positioning the connector housing and the plug.

In accordance with a still further embodiment of the Present Application, the optical connector is configured so that the abutting portion is provided with a pair of sidewall portions, and that when the front portion is positioned between the pair of sidewall portions, the rough positioning between the connector housing and the plug is achieved.

In accordance with the Present Application, the optical connector is configured so that the lock member is formed with the detection portion, capable of detecting the plug, and when the position of the front portion of the plug, connected to the optical waveguide, relative to the abutting portion of the connector housing is determined, the lock member is allowed to start the attitude changing operation. Owing to this configuration, it is not only possible to perform the positioning of the plug relative to the connector housing, but also to recognize the completion of the positioning of the plug. Accordingly, it is possible to provide an optical connector capable of realizing both unlocking and locking properties, and which has high durability and good operability and can be manufactured with a small size at a low cost and in a simple structure.

These and other objects, features and advantages of the Present Application will be clearly understood through a consideration of the following Detailed Description.

### BRIEF DESCRIPTION OF THE FIGURES

The organization and manner of the structure and operation of the Present Application, together with further objects and advantages thereof, may best be understood by reference to the following Detailed Description, taken in connection with the accompanying Figures, wherein like reference numerals identify like elements, and in which:

FIGS. 1A to 1C are views of an optical connector according to an embodiment of the Present Application, illustrating a state where a lock member is left open and a cable is maintained at its position prior to being connected, in which FIG. 1A is a perspective view of the optical connector, FIG. 1B is a perspective view of the cable and FIG. 1C is a side view thereof;

FIGS. 2A and 2B are views of the optical connector according to FIGS. 1A-C, illustrating a state where the lock member is closed and the cable has been connected, in which FIG. 2A is a perspective view thereof, and FIG. 2B is a side view thereof;

FIG. 3 is an exploded perspective view of a plug of the optical connector of FIGS. 1A-C;

FIG. 4 is a schematic side sectional view illustrating the connection relationship between a connection end portion of the cable and an optical connection portion and an electric connection portion of a receptacle of the optical connector of FIGS. 1A-C;

FIGS. 5A to 5D are first views illustrating an operation of fitting the plug to engage the receptacle connector according to the embodiment of the Present Application, in which FIGS. 5A-D are top plan views illustrating a series of operations thereof, FIGS. 5A-1-5D-1 are cross-sectional views illustrating the series of operations, taken along Arrows A-A in FIGS. 5A-D, and FIGS. 5B-2 and 5C-2 are enlarged views of Parts B and C in FIGS. 5B-1 and 5C-1, respectively;

FIGS. 6A to 6D are second views illustrating the operation of fitting the plug to engage the receptacle connector according to the embodiment of the Present Application, in which FIGS. 6A-D are top plan views illustrating a series of operations thereof, and FIGS. 6A-1-6D-1 are side views of FIGS. 6A-D, respectively, illustrating the series of operations;

FIGS. 7A to 7G are third views illustrating the operation of fitting the plug to engage the receptacle connector according to the embodiment of the Present Application, in which FIGS. 7A-G are perspective views illustrating a series of operations thereof; and

FIG. 8 is a perspective view of a conventional optical connector.

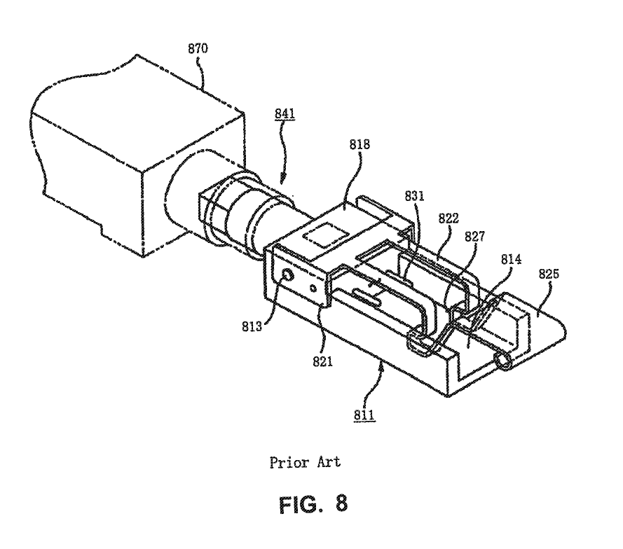

### DESCRIPTION OF THE PREFERRED EMBODIMENTS

While the Present Application may be susceptible to embodiment in different forms, there is shown in the Figures, and will be described herein in detail, specific embodiments, with the understanding that the disclosure is to be considered an exemplification of the principles of the Present Application, and is not intended to limit the Present Application to that as illustrated.

In the embodiments illustrated in the Figures, representations of directions such as up, down, left, right, front and rear, used for explaining the structure and movement of the various elements of the Present Application, are not absolute, but relative. These representations are appropriate when the elements are in the position shown in the Figures. If the description of the position of the elements changes, however, these representations are to be changed accordingly.

Referring to the Figures, receptacle connector 1 is mounted on a surface of a board such as a non-illustrated circuit board and functions as an optical connector for connecting cable 101 thereto. Cable 101 is a combined cable having an integrated optical waveguide and later-described conductive wires 151. Specifically, cable 101 is one in which a flexible flat plate-like cable such as a flexible printed circuit is laminated, by bonding, onto one surface of a strip-like optical waveguide to form an integrated body, or one in which a conductive pattern is formed on one surface of a strip-like optical waveguide. In addition, plug housing 130 is attached to an end portion of cable 101, and plug 120, as a plug connector which is a counterpart optical connector, is formed in the end portion. Moreover, plug 120 is engaged, by fitting, with receptacle connector 1, whereby cable 101 is connected to receptacle connector 1.

Moreover, the optical connector functions as a connector for connecting an optical waveguide thereto. Therefore, the optical connector does not need to be a cable for connecting a combined cable thereto, having integrated therewith an optical waveguide and conductive wires 151, as long as it is capable of connecting cables at least having an optical waveguide. However, in the present embodiment, for the sake of explanation, the optical connector will be described as being comprised of a connector capable of connecting thereto a combined cable having integrated therewith an optical waveguide and conductive wires 151.

Although the purpose of use of cable 101 is not particularly limited, it is suitably used in an electronic device in which a casing is divided into a plurality of parts, and neighboring parts are rotatably connected with each other, so that the cable is wired so as to pass through an inside of a hinge portion that rotatably connects the neighboring division parts. Moreover, cable 101 is capable of transmitting signals through serial transmission via the optical waveguide, for example, and is an excellent EMI countermeasure, and is thus suitably used for high-speed transmission of a large amount of signals. Furthermore, receptacle connector 1 is suitably used for being mounted on a surface of a board arranged within a casing of the electronic device.

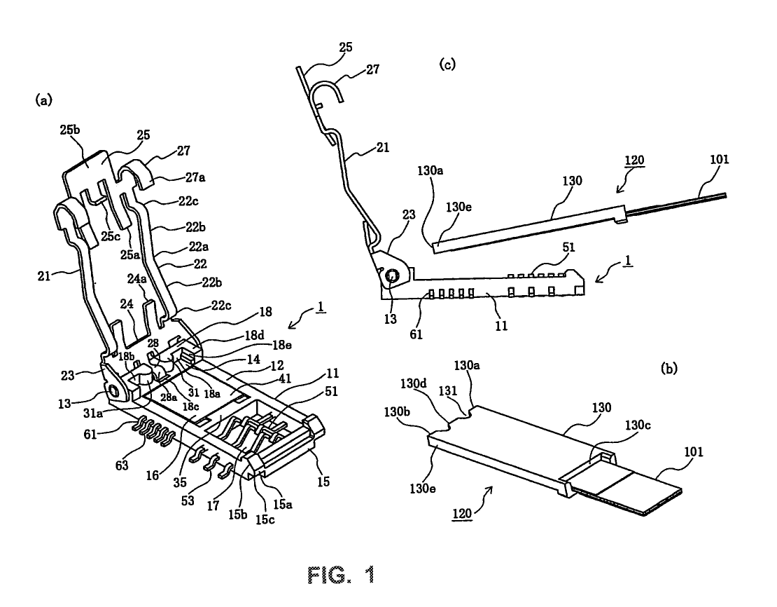

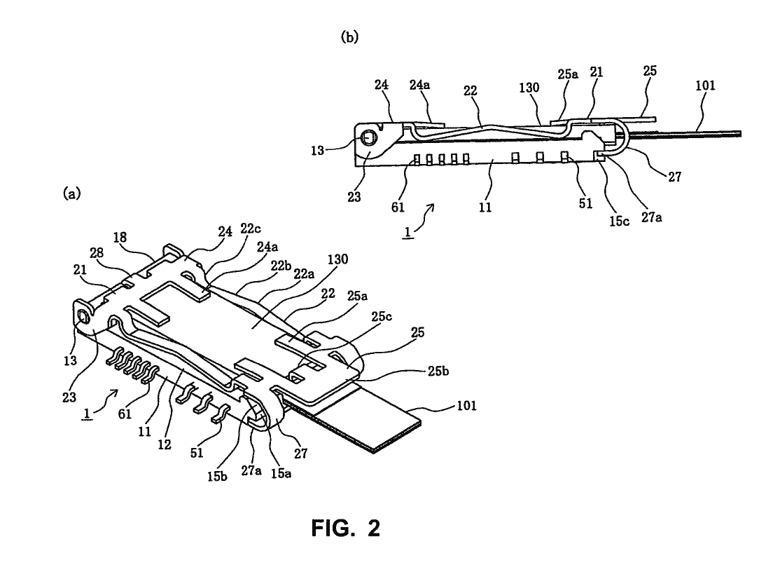

Receptacle connector 1 is provided with connector housing 11, integrally formed of an insulating material, and lock member 21, that is integrally formed of an elastically deformable material and attached to connector housing 11 in an attitude-changeable state. Lock member 21 may be formed by processing, e.g., bending and pressing, a metal plate. Moreover, lock member 21 is capable of changing its attitude by having a proximal end thereof (the lower end in FIG. 1C) rotatably connected to a distal end (the left end in FIG. 1C) of connector housing 11, so that it is rotated between an open position, as illustrated in FIG. 1, for mounting plug 120 onto connector housing 11 and a closed position, as illustrated in FIG. 2, for locking plug 120.

Lock member 21 is an approximately rectangular, hollow plate-like member and includes first crossbar portion 24 and second crossbar portion 25 configured to extend in a short-axis direction (width direction) and a pair of elongated strip plate-like flexible portions 22, configured to extend in a long-axis direction (vertical direction) so that both ends of first crossbar portion 24 and second crossbar portion 25 are connected with each other. Flexible portions 22 function as an extendable/contractible portion.

First crossbar portion 24 is disposed at a distal end of lock member 21, and proximal ends of pair of mounting leg parts 23 as an attachment portion are connected to both ends thereof in the short-axis direction. Each mounting leg part 23 extends in a direction approximately perpendicular to first crossbar portion 24 so that a distal end thereof is rotatably connected to a distal end of connector housing 11 via rotation shaft 13 of connector housing 11. In other words, mounting leg parts 23 can be said to be connected to one end of flexible portions 22 via first crossbar portion 24. Furthermore, proximal ends of first pressing portions 24a as a plug pressing portion configured to extend toward second crossbar portion 25 are connected between portions of first crossbar portion 24 connected to pair of flexible portions 22. In the example illustrated in the drawing figures, although two first pressing portions 24a are provided and configured as an elongated strip plate-like member, it may be configured as a plate-like large-width member and one pressing portion or three or more pressing portions may be provided.

Further, first crossbar portion 24 is connected to a proximal end of plate-like detection lever 28 which is configured to downwardly extend when positioned at a closed position thereof. Detection lever 28 functions as a detection portion which is capable of detecting plug 120 by making tight contact with at least a portion of plug 120. In the example illustrated in the drawing figures, detection lever 28 is a plate-like member having an approximately S shape or a crank shape in side view, in which the proximal end is connected to an edge of first crossbar portion 24 at an opposite side to second crossbar portion 25, a body thereof is curved at about 90 degrees to be connected to the proximal end and downwardly extends when it is at a closed position thereof, and distal end portion 28a is connected to a lower end, namely, a distal end of the body. Distal end portion 28a has a curved shape in side view which is curved at about 90 degrees to the proximal end, and has a distal end thereof being configured to extend in a direction opposite to second crossbar portion 25. In the example illustrated in the drawing figures, although detection lever 28 is configured as a small-width member and the number thereof is one, it may be configured as a large-width member and the number thereof may be two or more.

Second crossbar portion 25 is disposed at a rear end of lock member 21, and proximal ends of pair of latching arm parts 27 as a latched portion are connected to both ends on the rear end side in the long-axis direction. As illustrated in FIG. 1A, each latching arm parts 27 has a generally U shape in side view and extends in a direction away from first crossbar portion 24 to be downwardly bent so that distal end portion 27a thereof is directed toward first crossbar portion 24 to be engaged with or disengaged from connector housing 11. In other words, latching arm parts 27 can be said to be connected to one ends of flexible portions 22 via second crossbar portion 25. Moreover, at the closed position as illustrated in FIG. 2, distal end portions 27a are latched to lock projections 15a as a latching portion of connector housing 11. Furthermore, proximal ends of second pressing portions 25a as a plug pressing portion configured to extend toward first crossbar portion 24 are connected between portions of second crossbar portion 25 connected to pair of flexible portions 22. In the example illustrated in the drawing figures, although two second pressing portions 25a are provided and configured as an elongated strip plate-like member, it may be configured as a plate-like large-width member and one pressing portion or three or more pressing portions may be provided.

In addition, a proximal end of plate-like operation portion 25b extending in a direction away from first crossbar portion 24 is connected to a portion of second crossbar portion 25 disposed inner than the portions thereof connected to latching arm parts 27. Although operation portion 25b is a portion operated when an attitude of lock member 21 is to be changed, operation portion 25b may be appropriately omitted if not necessary.

In addition, proximal end of plate-like pressing portion 25c configured to extend toward the lower side is connected to the portion between two second pressing portions 25a of second crossbar portions 25. Pressing portion 25c is a member contacts with pressed portion 130c of plug housing 130, and presses plug 120 toward the distal of connector housing 11. In the example illustrated in the drawing figures, although one pressing portion 25c is provided and configured as a member with small-width, it may be configured as a member with large-width and two or more pressing portions may be provided.

Moreover, each flexible portion 22 has a generally dog-leg shape in side view as illustrated in FIG. 1C and is provided with bent portion 22a that is bent so as to upwardly project at the closed position as illustrated in FIG. 2, flat plate-like or straight-line shaped straight portions 22b connected to both sides of bent portion 22a, and connection portions 22c connecting both ends of bent portion 22 to first crossbar portion 24 and second crossbar portion 25. Since flexible portions 22 have such a lateral shape and are formed of an elastic material, they are capable of being elastically expanded or contracted. That is, since a distance between both ends of flexible portion 22 can be increased, it is possible to increase a distance between first crossbar portion 24 and second crossbar portion 25. Specifically, when bent portion 22a is downwardly pressed at the closed position, the degree of bending of bent portion 22a is decreased and thus an angle between straight portions 22b at both sides thereof is increased, and as a result, the distance between both ends of flexible portion 22 is increased. That is, flexible portion 22 is expanded or contracted in accordance with a change in the degree of bending of bent portion 22a.

In this example, connection portions 22c are curved so as to downwardly project at the closed position. Owing to this configuration, it is possible to decrease a height dimension of receptacle connector 1 without needing to change the degree of bending of bent portion 22a, and thus, the height of receptacle connector 1 at the closed position can be reduced. Moreover, connection portions 22c are not necessarily curved so as to downwardly project but may be curved so as to upwardly project. However, when it is not necessary to reduce the height, connection portions 22c may not be formed in a curved shape but in a flat shape: in such a case, the height dimension of receptacle connector 1 at the closed position is increased by the amount of the height dimension at the curved portions of connection portions 22c. Moreover, bent portion 22a may be bent so as to upwardly project at the closed position. In the example illustrated in the drawing figures, although bent portion 22a is disposed at an approximately center between first crossbar portion 24 and second crossbar portion 25, bent portion 22a may be disposed at a position close to first crossbar portion 24 or a position close to second crossbar portion 25. Two or more bent portions 22a may be provided. That is, it is not necessary to provide straight portions 22b, and an extending/contracting function may be provided to flexible portion 22 as long as at least one bent portion 22a is provided to flexible portion 22.

Owing to such a configuration as described above, lock member 21 is capable of locking plug 120 by pressing plug 120 against connector housing 11 from upper and rear sides thereof at the closed position as illustrated in FIG. 2 in a state where plug 120 is accurately positioned relative to connector housing 11. Moreover, when an operator downwardly presses bent portion 22a by the operator, the entire body of lock member 21 is extended in the long-axis direction so that the latched state of distal end portion 27a of latching arm part 27 is released. Therefore, it is easy to release the lock state of plug 120.

Connector housing 11 is a plate-like member having a generally rectangular shape in top plan view and is provided with pair of sidewall portions 12 extending in the long-axis direction and rear-end wall portion 15 extending in the width direction at a rear end thereof so as to connect sidewall portions 12 at both sides thereof. Connector housing 11 is further provided with guide portion 14, optical connection portion 16, and electric connection portion 17 being arranged in tandem in the long-axis direction from a distal end thereof toward the rear end. Rotation shaft 13 is attached in the vicinity of a distal end of sidewall portions 12, and mounting leg parts 23 of lock member 21 are rotatably attached to rotation shaft 13.

Opposite sidewall portions 12 are connected with each other, at the distal end thereof, by guide portion 14 while they are connected with each other, at a middle thereof, by partition wall portion 35 extending in the width direction so as to partition optical connection portion 16 and electric connection portion 17.

Moreover, in the vicinity of both ends in the width direction of rear-end wall portion 15, that is, in rear end surfaces of opposite sidewall portions 12, lock projections 15a as a latching portion are formed. When lock member 21 is position at the closed position, distal end portions 27a of latching arm parts 27 are engaged with lock projections 15a so that lock member 21 is latched to connector housing 11. As a result, plug 120 is locked. Moreover, since the upper surfaces of lock projections 15a are configured as tapered surfaces 15b that are downwardly sloped toward a rear side so that distal end portions 27a can be easily slid on the upper surfaces. Furthermore, concave portions on the lower surface sides of lock projections 15a are configured as concave latching portions 15c so that distal end portions 27a can be firmly latched. Lock projections 15a may be formed on side surfaces of opposite sidewall portions 12.

Guide portion 14 is provided with a flat upper surface as a guide surface and abutting portion 18 as a positioning portion configured to upwardly project from the upper surface. Abutting portion 18 is a wall-like portion which is integrally formed at a front end of guide portion 14 so as to extend in the width direction, and is configured to be engaged with front end portion 130a as a front portion of plug housing 130. Rear end portion 18a as a positioning end of abutting portion 18 opposes a front end portion of plug 120, that is, front end portion 130a of plug housing 130. Abutting portion 18 is formed with guiding sidewall portions 18d as sidewall portions extending toward the rear side, which are formed at both ends in the width direction thereof. The inner walls of guiding sidewall portions 18d function as guiding sidewalls 18e and guide plug 120. Guiding sidewall portions 18d are formed to be integral with sidewall portions 12, and rotation shaft 13 is specifically attached to guiding sidewall portions 18d.

Moreover, abutting portion 18 is formed with convex portions 31 which have a sector-like shape and are configured to rearwardly project from rear end portion 18a. In the example illustrated in the drawing figures, although convex portions 31 have a sector-like shape having a center angle of about 180 degrees, i.e., an approximately semicircular shape, the shape thereof is not particularly limited. That is, as long as convex portions 31 have circular arc-shaped end portion 31a having an approximately circular arc shape, they do not necessarily have a semicircular or sector-like shape but may have an arbitrary shape. Moreover, in the example illustrated in the drawing figures, although flat portions 18b are formed into a straight-line shape, it does not need to be a straight line in a strict sense of meaning but it may be a smooth curve. Furthermore, in the example illustrated in the drawing figures, although two convex portions 31 are provided, the number thereof may be one or three or more.

Further, at least a portion of detection lever 28 is positioned in abutting portion 18. Moreover, when lock member 21 is at the open position, at least a portion of detection lever 28 is exposed from abutting portion 18. In the example illustrated, lever accommodation-concave portion 18c is formed so as to penetrate through a portion of an upper surface of each rear end portion 18a and guide portion 14. Lever accommodation-concave portion 18c is a concave portion which is configured to accommodate therein at least a portion of detection lever 28 of lock member 21. Lever accommodation-concave portion 18c is formed to be deeply recessed from the upper surface of guide portion 14 in order to accommodate therein detection lever 28 rotating about rotation shaft 13 and has a groove-shaped concave portion having an approximately sector-like shape in side view as will be described later. In the example illustrated in the drawing figures, although lever accommodation-concave portion 18c is formed between pair of convex portions 31, the position thereof may be appropriately adjusted to comply with the position of detection lever 28. Moreover, in the example illustrated in the drawing figures, although the number of lever accommodation-concave portions 18c is one, the number thereof may be appropriately changed to two or more to comply with the number of detection levers 28.

On the other hand, concave portion 131 configured to be engaged with convex portion 31 is formed in front end portion 130a of plug housing 130 of plug 120. In the example illustrated in the drawing figures, although concave portion 131 is opened to front end portion 130a and has a triangular shape or a generally V shape having two oblique side portions 131a, which are inclined in mutually opposite directions with respect to a straight line parallel to the long-axis direction of plug 120, the shape of concave portion 131 is not particularly limited. That is, as long as concave portion 131 is opened to front end portion 130a and has at least portions flat portions 130b being present at both sides thereof and two oblique side portions 131a which are inclined in mutually opposite directions with respect to a straight line parallel to the long-axis direction of plug 120, thus allowing at least a portion of convex portion 31 to be inserted therein, it does not need to have a triangular shape or a generally V shape, but may have a trapezoidal shape, for example, and have an arbitrary shape. In the example illustrated in the drawing figures, although two concave portions 131 are provided, the number of concave portions 131 may be one or three or more. Moreover, the number of concave portion 131 does not need to correspond to the number of convex portions 31. For example, the number of concave portions 131 may be smaller than the number of convex portions 31 in a configuration that two or more convex portions 31 are inserted in one concave portion 131.

Further, at least a portion of flat portion 130b functions as lever abutting portion 130d which makes tight contact with detection lever 28 of lock member 21. Lever abutting portion 130d is a portion that rotates lock member 21 by making tight contact with detection lever 28 when the positioning between front end portion 130a of plug housing 130 and abutting portion 18 of connector housing 11 is carried out in order to mount plug 120 on connector housing 11. In the example illustrated in the drawing figures, although lever abutting portion 130d is formed between pair of concave portions 131, the position thereof may be appropriately adjusted to comply with the position of detection lever 28. Moreover, in the example illustrated in the drawing figures, although the number of lever abutting portions 130d is one, the number thereof may be appropriately changed to two or more to comply with the number of detection levers 28.

When convex portion 31 of abutting portion 18 is engaged with concave portion 131 of plug housing 130, plug 120 mounted on connector housing 11 can be guided to a predetermined position with high accuracy. Hence, the positioning of plug 120 relative to receptacle connector 1 is carried out with high accuracy.

Moreover, at this time, front end portion 130a and neighboring portions thereof in side face portions 130e of plug housing 130 are guided to guiding sidewalls 18e of guiding sidewall portions 18d, whereby the rough positioning in the width direction of connector housing 11 and plug 120 can be carried out in an easy manner. That is, by moving front end portion 130a of plug housing 130 and the neighboring portions thereof to be positioned between guiding sidewall portions 18d on both sides thereof, the brief positioning between connector housing 11 and plug 120 can be achieved. In this way, the positioning between connector housing 11 and plug 120 can be carried out in an easy manner with high precision by the engagement between convex portions 31 and concave portions 131.

Furthermore, at this time, since lever abutting portion 130d of plug housing 130 is brought into tight contact with detection lever 28, thereby allowing lock member 21 to start its rotation, the operator is able to easily recognize that the positioning between receptacle connector 1 and plug 120 is completed. Moreover, plug 120 is a thin plate-like member having an approximately rectangular shape in top plan view, and when plug 120 is mounted on connector housing 11, a lower surface thereof opposes an upper surface of connector housing 11.

In addition, optical connection portion 16 is a portion that performs transferring of light to the optical waveguide of cable 101 and is configured as a concave portion capable of receiving therein an optical device such as a control IC or the like as a light receiving/emitting control device which is provided with a later-described optical semiconductor device 72, e.g., a light receiving element and a light emitting element, and a control circuit for controlling optical semiconductor device 72. In the example illustrated in the drawing figures, an upper surface of the concave portion is sealed by thin plate-like sealing plate 41 which is formed of a translucent material such as glass.

Moreover, optical connection portion 16 receives optical terminals 61 which are formed of a conductive material such as metal and connected to optical semiconductor device 72 or the control IC. Optical terminals 61 are provided with tail portions 63 as board connection portions, which are connected, by soldering or the like, to connection pads formed on a surface of a board, and tail portions 63 are projected outward from the lateral surfaces of connector housing 11.

Furthermore, electric connection portion 17 is a portion which is electrically connected to conductive wires 151 of cable 101, and is configured as a concave portion which is capable of receiving therein electric connection terminals 51 formed of a conductive material such as metal. Electric connection terminals 51 are provided with contact portions that are formed in the vicinity of free ends thereof and are curved so as to be convex toward the upper side and tail portions 53 as a board connection portion connected, by soldering or the like, to connection pads formed on a surface of a board, so that tail portions 53 are projected outward from the lateral surfaces of connector housing 11.

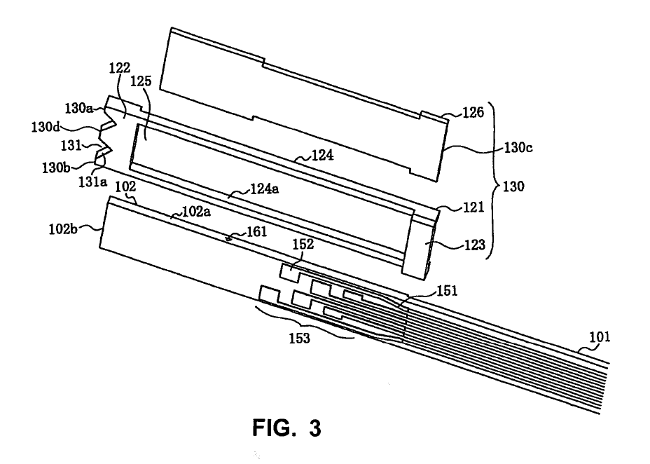

Next, a detailed description of the structure of plug 120 will be provided. Although cable 101 is a thin plate member having an elongated strip shape, only a portion in the vicinity of a front end thereof (the left end) is illustrated in FIG. 3. Moreover, connection end portion 102 is formed within a range of a predetermined length from front end surface 102b thereof.

On the lower surface of cable 101, a plurality of lines of foil-like conductive wires 151 formed of a conductive material such as metal is arranged in parallel with one another at a predetermined pitch on an insulating layer of cable 101. Moreover, another insulating film is covered on a lower side of conductive wires 151. Furthermore, the insulating film is removed in connection end portion 102, exposing the lower surface of conductive wires 151.

In addition, connection pad portions 152 having a large width are formed at distal ends of respective conductive wires 151. Respective connection pad portions 152 are formed at positions corresponding to the contact portions of electric connection terminals 51 received in electric connection portion 17 of connector housing 11 in a state where cable 101 is connected to receptacle connector 1. Moreover, a portion within the range, where connection pad portions 152 are arranged, functions as plug-side electric connection portion 153. Although connection pad portions 152 may be arranged in an arbitrary form, it is preferable that they are arranged in a zigzag form, and arranged in tandem in an axial direction of cable 101, as illustrated in the drawing figures. Owing to this configuration, it is possible to arrange a number of connection pad portions 152 without needing to increase the width of connection end portion 102, and as a result, it is possible to suppress any increase in the width dimension of plug 120.

Moreover, at a portion of connection end portion 102 disposed closer the front end than connection pad portions 152, optical path conversion portion 161 as a plug-side optical connection portion is formed. Optical path conversion portion 161 is provided with later-described slope surface 162 functioning as a mirror surface and is capable of changing a direction of light transmitted from the optical waveguide to about a right angle. That is, optical path conversion portion 161 changes an optical path extending in an axial direction of cable 101 to an optical path extending in a direction perpendicular to the lower surface of cable 101. Owing to this configuration, light transmitted through the optical waveguide can be emitted toward the lower side from the lower surface of cable 101, and light incident onto the lower surface of cable 101 from the lower side can be introduced to the optical waveguide. Optical path conversion portion 161 is formed at a position corresponding to optical semiconductor device 72 received in optical connection portion 16 of connector housing 11 in a state where cable 101 is connected to receptacle connector 1.

Plug housing 130 includes plug housing body 121 configured as a rectangular frame-like member extending in an axial direction of cable 101 and plug top plate 126 configured as a rectangular plate-like member extending in the axial direction of cable 101. Plug housing body 121 is a member integrally formed of an insulating material such as synthetic resin and is provided with pair of sidewall portions 124 extending in the long-axis direction, front crossbar portion 122 configured to connect front ends sidewall portion 124 with each other, and rear crossbar portion 123 configured to connect rear ends of sidewall portions 124 with each other. Moreover, rectangular opening 125 penetrating through plug housing body 121 in a thickness direction thereof, has a perimeter thereof defined by sidewall portions 124, the front crossbar portion 122, and rear crossbar portion 123.

The dimension in the thickness direction of sidewall portions 124 is identical to a dimension in the thickness direction of connection end portion 102 of cable 101. Moreover, sidewall portions 124 determine the position in the width direction of cable 101.

Moreover, front crossbar portion 122 functions as a positioned portion of plug 120 and is configured as a rectangular plate-like member having a rectangular sectional shape, being provided with a flat lower surface as a guided surface and front end portion 130a as the positioning end. Moreover, concave portion 131 is formed in front end portion 130a. Front crossbar portion 122 functions as a guided portion when plug 120 is mounted on the connector housing 11, concave portion 131 is engaged with convex portion 31 of connector housing 11, while front end portion 130a opposes rear end portion 18a of abutting portion 18 of connector housing 11, and the lower surface of front crossbar portion 122 opposes an upper surface of guide portion 14 of connector housing 11. Moreover, the lower surface of front crossbar portion 122 is formed so as to be even with the lower surface of sidewall portions 124. Furthermore, the rear end surface of front crossbar portion 122 is brought into tight contact with front end surface 102b of connection end portion 102 of cable 101, so that the position in the axial direction of cable 101 is determined. In addition, the dimension in the thickness direction of front crossbar portion 122 is substantially identical to the sum of a dimension in the thickness direction of sidewall portions 124 and a dimension in the thickness direction of plug top plate 126.

Rear crossbar portion 123 is a rectangular plate-like member having a rectangular sectional shape and is provided with a flat upper surface, being configured such that an upper surface thereof is brought into tight contact with the lower surface of connection end portion 102 of cable 101, so that cable 101 is supported from the lower side. Rear crossbar portion 123 is connected to sidewall portions 124 so that the upper surface thereof is at the same surface as the lower surface of sidewall portions 124. Therefore, the rear end surface of plug housing body 121 has an approximately U shape as viewed from a rear side thereof.

Moreover, plug top plate 126 is an approximately rectangular thin plate-like member and is fixed by being attached to plug housing body 121 so that opening 125 is blocked from the upper side. In the example illustrated in the drawing figures, although plug housing body 121 and plug top plate 126 are formed to be separated from each other, plug housing body 121 and plug top plate 126 may be integrally formed therewith. Furthermore, it is preferable that plug top plate 126 functions as a shielding plate. For example, it is preferably configured as one formed of a metal plate, one obtained by over-molding a metal plate with synthetic resin, one formed of a laminated composite plate containing a metal layer, or one formed of a conductive composite material in which a conductive material is mixed into a matrix of synthetic resin or the like.

In addition, the length of plug top plate 126, that is, a dimension thereof in the long-axis direction, is substantially the same as a dimension of plug housing body 121 as measured from the rear end surface of front crossbar portion 122 to the front end surface of rear crossbar portion 123. Moreover, the width of plug top plate 126, that is, a dimension thereof in the short-axis direction, is substantially the same as a dimension of plug housing body 121 as measured from an outer surface of one sidewall portions 124 to an outer surface of other sidewall portions 124.

The rear end surface of plug top plate 126 functions as pressed portion 130c of plug housing 130, so that when lock member 21 is moved to the closed position, pressed portion 130c is brought into tight contact with pressing portion 25c to be pressed toward the distal end of connector housing 11. For this reason, the entire body plug 120 is pressed toward the distal end of connector housing 11 by lock member 21.

When plug top plate 126 is fixed to plug housing body 121 so that the front end surface of plug top plate 126 is brought into tight contact with the rear end surface of front crossbar portion 122, the assembly of plug housing 130 is completed. In this case, the whole surface of opening 125 and the upper surface of sidewall portions 124 are covered by plug top plate 126. Moreover, when plug housing body 121 and plug top plate 126 are integrally formed therewith, plug top plate 126 is originally attached to plug housing body 121. In assembled plug housing 130, the upper surface of front crossbar portion 122 is at the same surface as plug top plate 126.

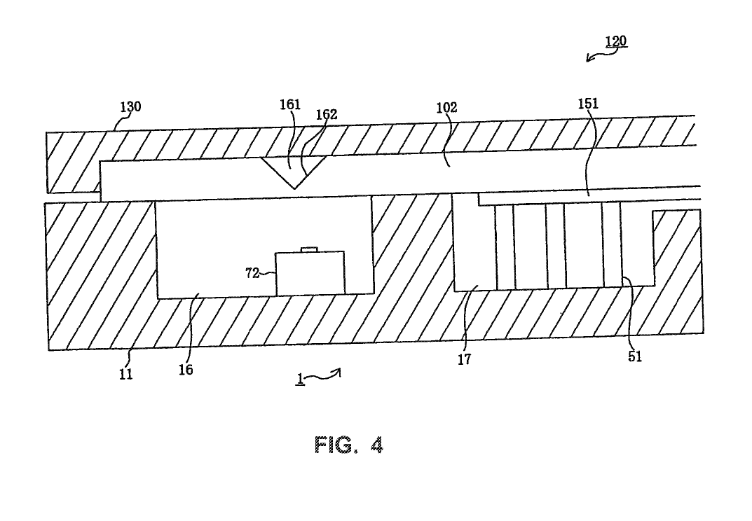

Next, a description of the connection relationship between connection end portion 102 of cable 101 and optical connection portion 16 and electric connection portion 17 of receptacle connector 1 will be provided. Since front end portion 130a of plug housing 130 is engaged with the rear end portion 18a of abutting portion 18 of connector housing 11 in a state where plug 120 is connected to receptacle connector 1, the position of plug 120 relative to connector housing 11 is fixed with respect to the axial direction and the width direction of cable 101. Therefore, as will be understood from FIG. 4, in a state where plug 120 is connected to receptacle connector 1, optical path conversion portion 161 of plug 120 is disposed at a position right above optical semiconductor device 72 received in optical connection portion 16 of receptacle connector 1. Moreover, with respect to the width direction of cable 101, optical path conversion portion 161 of plug 120 is disposed at a position right above optical semiconductor device 72. Owing to this configuration, cable 101 and receptacle connector 1 are optically connected with each other.

That is, light emitted from a light emitting surface of optical semiconductor device 72 is incident onto cable 101 from the lower side thereof, reflected from slope surface 162 disposed close to the rear side of optical path conversion portion 161, introduced to the core portion corresponding to light emitting element 72b while changing a traveling direction thereof to about a right angle, and transmitted through the core portion along axial direction of the cable 101. On the other hand, light transmitted through the core portion along the axial direction of cable 101 is reflected from slope surface 162 disposed close to the rear side of optical path conversion portion 161, emitted toward the lower side from the lower surface of cable 101 while changing a traveling direction thereof to about a right angle, and received by a light receiving surface of optical semiconductor device 72.

In addition, plug-side electric connection portion 153 of plug 120 is disposed at a position right above electric connection portion 17 of receptacle connector 1, and respective connection pad portions 152 are brought into electrical contact with the contact portions of corresponding ones of electric connection terminals 51 received in electric connection portion 17.

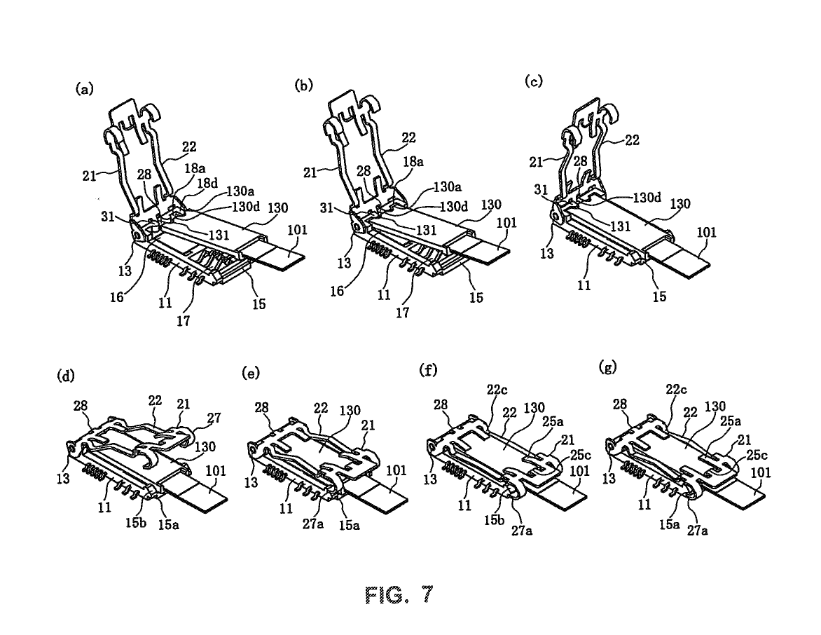

Next, a description of the operation of connecting cable 101 to receptacle connector 1 by tightly fitting plug 120 to be engaged with receptacle connector 1 will be provided below. First, as illustrated in FIGS. 5A, 5A-1 and 7A, lock member 21 of receptacle connector 1 is moved to be positioned at the open position, and plug 120 is positioned above connector housing 11. In this case, the lower surface of plug 120, that is, the exposed surface of each of connection pad portions 152 is positioned so as to oppose the upper surface of connector housing 11. At the same time, plug 120 is positioned at an obliquely rear upper side of connector housing 11 so that front end portion 130a of plug housing 130 is oriented obliquely downward.

Subsequently, plug 120 is moved so that front end portion 130a is moved obliquely downward, and as illustrated in FIGS. 5B, 5B-1 and 7B, front end portion 130a of plug housing 130 and the neighboring portions thereof are moved to be positioned between guiding sidewall portions 18d on both sides of connector housing 11. That is, front end portion 130a of plug housing 130 is engaged, from an obliquely upper side, with rear end portion 18a of connector housing 11. In this way, front end portion 130a and the neighboring portions thereof in side face portions 130e of plug housing 130 are guided to guiding sidewalls 18e, whereby the rough positioning in the width direction of connector housing 11 and plug 120 is carried out.

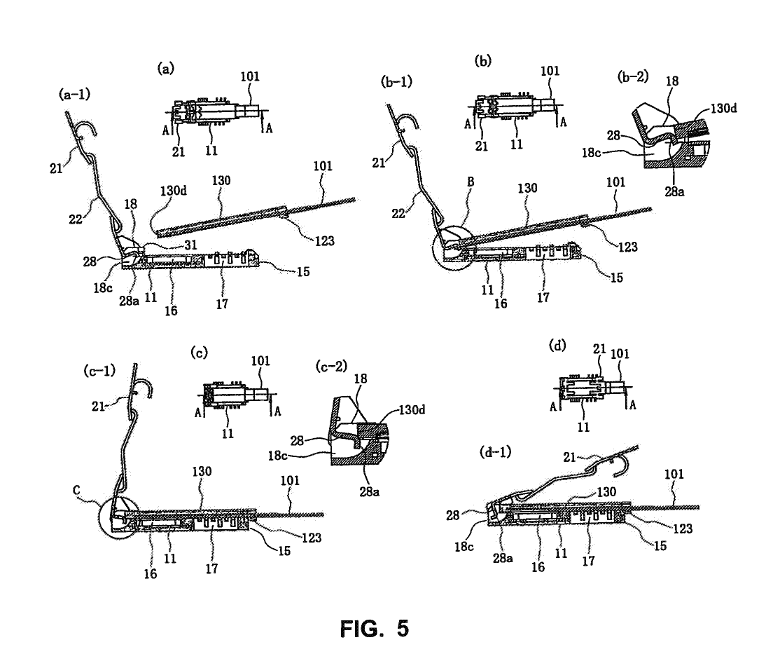

Then, concave portions 131 of plug housing 130 and convex portions 31 of connector housing 11 are opposed to each other, and lever abutting portion 130d of plug housing 130 and detection lever 28 of lock member 21 are opposed to each other. Moreover, detection lever 28 has at least a portion thereof being exposed from abutting portion 18 when lock member 21 is at the open position, and in the example illustrated in the drawing figures, a surface on a rear end side of distal end portion 28a is formed to be substantially even with a surface on a rear end side of each convex portion 31. Therefore, as illustrated in FIG. 5B-2, lever abutting portion 130d is brought into tight contact with distal end portion 28a of detection lever 28 in a state where the rough positioning in the width direction of connector housing 11 and plug 120 is achieved. It should be noted that the position of the surface on the rear end side of distal end portion 28a when lock member 21 is at the open position may be appropriately changed. For example, the position may be located on the rear side (closer to rear-end wall portion 15) of the surface on the rear end side of each of convex portions 31 and may be located on the front side (distant from rear-end wall portion 15) of the surface on the rear end side of each convex portion 31.

Moreover, when plug 120 is further moved so that front end portion 130a is moved obliquely downward, the engagement between concave portions 131 of plug housing 130 and convex portions 31 of connector housing 11 is started. At the same time with this, since distal end portion 28a of detection lever 28 is pressed by lever abutting portion 130d, detection lever 28 is rotated in the clockwise direction in FIG. 5B-2, so that the entire body of lock member 21 is rotated in the clockwise direction about rotation shaft 13. Moreover, since detection lever 28 is accommodated in groove-shaped lever accommodation-concave portion 18c which has an approximately sector-like shape in side view, lock member 21 is smoothly rotated.

Subsequently, plug 120 is rotated in the clockwise direction about front end portion 130a so that the entire body of plug 120 is placed on connector housing 11 as illustrated in FIGS. 5C, 5C-1 and 7C. Moreover, plug 120 is further pressed by moving it toward a distal end of connector housing 11. In this way, concave portions 131 and convex portions 31 are engaged with each other, and plug 120 is accurately positioned relative to connector housing 11.

On the other hand, as illustrated in FIG. 5C-2, since distal end portion 28a of detection lever 28 is further pressed by lever abutting portion 130d, detection lever 28 is further rotated in the clockwise direction, so that the entire body of lock member 21 is further rotated in the clockwise direction about rotation shaft 13, thereby passing its position corresponding to twelve o'clock, as illustrated in FIG. 5C-1. That is, the angle between lock member 21 and connector housing 11 becomes smaller than 90 degrees. In this way, lock member 21 is further rotated in the clockwise direction by its own weight. That is, lock member 21 performs an operation of changing its attitude toward the closed position. Then, the operator is able to recognize that plug 120 is accurately positioned relative to connector housing 11 by visually recognizing the attitude changing operation of lock member 21, which is automatically performed.

Here, the positioning by the engagement between concave portions 131 and convex portions 31 will be described. In the example illustrated in the drawing figures, the number of convex portions 31 formed in rear end portion 18a of abutting portion 18 of connector housing 11 is two, and they have an approximately semicircular shape. Moreover, the number of concave portions 131 formed in front end portion 130a of plug housing 130 is two, and they have a triangular shape. Furthermore, at least a portion of respective one of convex portions 31 is inserted to be engaged with respective concave portion 131.

As described above, when plug 120 is pressed toward the front end of connector housing 11 when plug 120 is being mounted on connector housing 11, front end portion 130a of plug housing 130 is engaged with rear end portion 18a of abutting portion 18 of connector housing 11, so that plug 120 is positioned relative to connector housing 11.

In this case, concave portions 131 have a triangular shape or a generally V shape and convex portions 31 have a semicircular shape. Hence, even when plug 120 and connector housing 11 are in a positional relationship that they are slightly misaligned in the width direction of connector housing 11, when plug 120 is frontwardly moved relative to connector housing 11 to cause convex portions 31 to be inserted in concave portions 131, circular arc-shaped end portions 31a of convex portions 31 are slid along oblique side portions 131a of concave portions 131. In this way, the misalignment in the width direction of connector housing 11 is automatically corrected. That is, since convex portion 31 and concave portion 131 capable of mutually engaging with each other have a semicircular shape and a triangular shape, respectively, even when the positioning of plug 120 relative to connector housing 11 is roughly carried out when convex portion 31 is being inserted in concave portion 131, they are automatically guide into engagement with each other, so that plug 120 and connector housing 11 are accurately positioned relative to each other.

In this way, in a state where plug 120 is positioned relative to connector housing 11, and the relative positions of plug 120 and connector housing 11 are fixed, when the engagement state of front end portion 130a and rear end portion 18a is viewed in a microscopic scale, front end portion 130a and rear end portion 18a are in a multi-point contact state where they are mutually contacted at a plurality of points. As a result, the positioning of plug 120 relative to connector housing 11 is carried out with high precision with respect to the axial direction, the width direction of cable 101 and the Z-axis direction.

Moreover, lock member 21 is further rotated in the clockwise direction by its own weight after it assumes such an attitude as illustrated in FIGS. 5C, 5C-1 and 7C. As a result, lock member 21 assumes such an attitude wherein it overlaps the upper surface of plug 120 placed on connector housing 11, as illustrated in FIGS. 5D, 5D-1, 6A, 6A-1 and 7D.

Subsequently, lock member 21 is further rotated in the clockwise direction by its own weight, and stops its rotation when distal end portions 27a of latching arm parts 27 are brought into tight contact with the upper surfaces, that is, tapered surfaces 15b of lock projections 15a of connector housing 11, as illustrated in FIGS. 6B, 6B-1 and 7E. Moreover, lock member 21 continues its attitude changing operation toward the closed position by its own weight after the attitude changing operation from the open position is started. That is, after lock member 21 starts its rotation by its own weight at such an attitude and position as illustrated in FIGS. 5C, 5C-1 and 7C, lock member 21 performs its attitude changing operation at once until it assumes such an attitude as illustrated in FIGS. 6B, 6B-1 and 7E without stopping in the midway thereof at such an attitude and position as illustrated in FIGS. 5D, 5D-1, 6A, 6A-1 and 7D, for example.

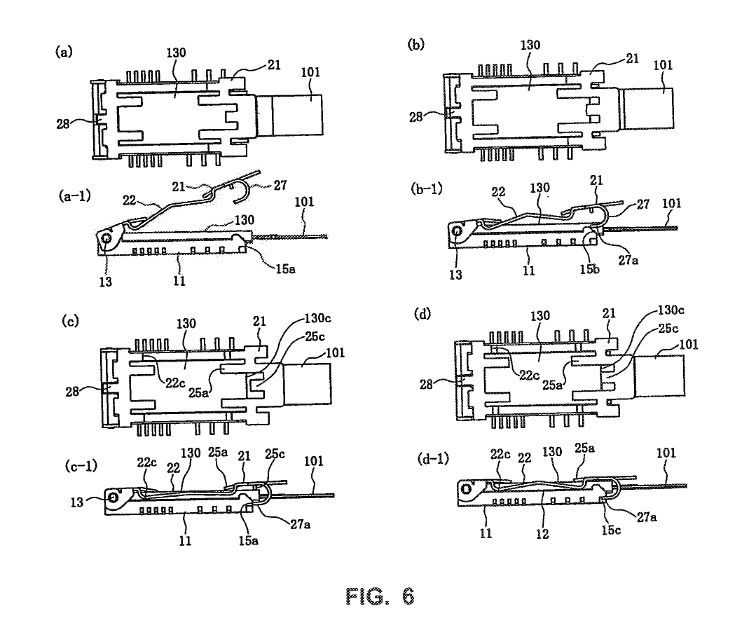

Subsequently, when lock member 21 is further rotated by an operator's fingers or the like so that latching arm parts 27 are moved downward, distal end portions 27a are slid along tapered surfaces 15b, and thus, latching arm parts 27 are displaced in a direction (rightward in FIGS. 6B and 6B-1) away from rotation shaft 13. Then, flexible portion 22 having an elastic property is expanded so that bent portion 22a is elastically deformed. Moreover, as illustrated in FIGS. 6C, 6C-1 and 7F, when distal end portions 27a of latching arm parts 27 of lock member 21 are brought into tight contact with the apex portions of lock projections 15a of connector housing 11, flexible portion 22 is in its most expanded state. As will be understood from FIG. 6C, in such a state, since pressing portion 25c of lock member 21 is located closer to the rear side than pressed portion 130c of plug housing 130, pressing portion 25c does not interfere with plug housing 130.

Moreover, when lock member 21 is further rotated from the states as illustrated in FIGS. 6C, 6C-1 and 7F so that latching arm parts 27 are further moved downward, the states as illustrated in FIGS. 6D, 6D-1 and 7G are obtained. In this case, distal end portions 27a are separated apart from the apex portions of lock projections 15a to be inserted into concave latching portions 15c on the lower surface side of lock projections 15a, as illustrated in FIG. 6D-1. Moreover, bent portion 22a restores to its original shape by a spring's restoring force so that flexible portion 22 is extended and contracted to restore its original shape. Moreover, distal end portions 27a are engaged with the lower surfaces of lock projections 15a. In this way, lock member 21 is latched to connector housing 11 at the closed position as illustrated in FIGS. 6D, 6D-1 and 7G, thereby locking plug 120.

In addition, since flexible portion 22 is extended and contracted to restore to its original shape, pressing portion 25c is displaced in the direction of rotation shaft 13 to be brought into tight contact with pressed portion 130c of plug housing 130, thereby pressing pressed portion 130c toward the distal end of connector housing 11 by an urging force as a spring force of bent portion 22a, as illustrated in FIG. 6D. Therefore, the entire body of plug 120 is pressed toward the distal end of connector housing 11 by lock member 21. As a result, since front end portion 130a and rear end portion 18a are in a multi-point contact state at three or more points, the position and the attitude of plug 120 relative to connector housing 11 can be stably maintained.

In addition, since by the extendable/contractible of flexible portion 22, distal end portions 27a of latching arm parts 27 receive a force exerted in a direction toward rotation shaft 13, the engagement range between distal end portions 27a and the lower surfaces of lock projections 15a becomes the maximum, and thus, the lock reliability is improved. Moreover, when lock member 21 is moved to the closed position, similar to the example illustrated in FIG. 6D-1, connection portions 22c of flexible portion 22 are brought into tight contact with the upper surfaces of sidewall portions 12. However, connection portions 22c may not be brought into tight contact with the upper surfaces of sidewall portions 12.

In this manner, as illustrated in FIGS. 2, 6D, 6D-1 and 7G, plug 120 is locked by being tightly fitted with receptacle connector 1, and thus, cable 101 is firmly connected to receptacle connector 1. It is to be noted that plug 120 does not necessarily be moved obliquely downward after it is positioned at an obliquely rear upper side of connector housing 11 so that front end portion 130a of plug housing 130 is oriented obliquely downward.

For example, plug 120 may be lowered relative to connector housing 11 so as to be engaged, by fitting, with connector housing 11 after plug 120 is positioned above connector housing 11 so that the lower surface of plug 120 and the upper surface of connector housing 11 are opposed to each other. In this case, plug 120 is lowered so that front end portion 130a of plug housing 130 is positioned slightly closer to the rear side than rear end portion 18a of abutting portion 18 of connector housing 11 and that front end portion 130a of plug housing 130 is positioned between guiding sidewall portions 18d on both sides of connector housing 11. When plug 120 is placed on connector housing 11, it is moved toward the distal end of connector housing 11. After plug 120 is placed on connector housing 11, it is pressed toward the distal end of connector housing 11, so that plug 120 is positioned relative to connector housing 11.

Moreover, for example, plug 120 is moved to be disposed at the rear side of connector housing 11 so that the lower surface of plug 120 is approximately parallel to and slightly above the upper surface of connector housing 11, and thereafter, plug 120 is moved toward the distal end of connector housing 11. As a result, front end portion 130a of plug housing 130 is engaged with rear end portion 18a of abutting portion 18 of connector housing 11. After plug 120 is placed on connector housing 11, plug 120 is pressed toward the distal end of connector housing 11, so that plug 120 is positioned relative to connector housing 11.

In this way, since the attitude and the movement direction of plug 120 can be appropriately chosen when plug 120 is engaged with receptacle connector 1, it is possible to provide a high degree of freedom in the operation. For example, even when other components such as an electronic component, are already mounted on the surroundings of receptacle connector 1, by appropriately choosing the attitude and the movement direction of plug 120, it is possible to engage fitting plug 120 with receptacle connector 1.

Moreover, since convex portion 31 and concave portion 131 capable of mutually engaging with each other have a semicircular shape and a triangular shape, respectively, even when the positioning of plug 120 relative to connector housing 11 is roughly carried out when convex portion 31 is being inserted in concave portion 131, they are automatically guide into engagement with each other, so that plug 120 and connector housing 11 are accurately positioned relative to each other. Therefore, it is possible to easily perform the operation of fitting plug 120 to be engaged with receptacle connector 1.

Furthermore, by moving front end portion 130a of plug housing 130 and the neighboring portions thereof to be positioned between guiding sidewall portions 18d on both sides of connector housing 11, the rough positioning in the width direction of connector housing 11 and plug 120 is carried out. Therefore, the positioning between connector housing 11 and plug 120 can be carried out in an easy manner with high precision by the engagement between convex portions 31 and concave portions 131.

In addition, when convex portions 31 are inserted into concave portions 131, lever abutting portion 130d of plug 120 is brought into tight contact with distal end portion 28a of detection lever 28. Since distal end portion 28a of detection lever 28 is pressed by lever abutting portion 130d, detection lever 28 is rotated so that body lock member 21 is rotated, and lock member 21 is rotated toward the closed position by its own weight. Therefore, the operator is able to recognize that plug 120 is accurately positioned relative to connector housing 11 by visually recognizing the rotation of lock member 21, which is automatically performed.

Furthermore, when the position of plug 120 relative to connector housing 11 is fixed, optical path conversion portion 161, as the plug-side optical connection portion, and plug-side electric connection portion 153 of plug 120 are positioned so as to oppose optical connection portion 16 and electric connection portion 17 of connector housing 11, respectively. Moreover, the position in the thickness direction of plug 120 is determined when the lower surface of front crossbar portion 122 is brought into tight contact with the upper surface of guide portion 14. In addition, front end portion 130a of plug housing 130 is engaged with rear end portion 18a of abutting portion 18 of connector housing 11. Furthermore, the side surfaces in the vicinity of the rear end of plug 120 are engaged with the rearward engagement protrusive walls of connector housing 11. Therefore, the positional relationship between plug 120 and connector housing 11 can be stably maintained. Owing to these configurations, the positional relationship is not disturbed even upon receipt of an unexpected external force.

Next, a description of the operation of unlocking plug 120 in order to remove the plug 120 from receptacle connector 1 will be provided. As illustrated in FIGS. 2, 6D, 6D-1 and 7G, it is necessary to unlock plug 120 in order to remove plug 120 from engagement with receptacle connector 1. In this case, the operator downwardly presses bent portions 22a of flexible portions 22 with the operator's fingers or the like. In this way, bent portions 22a are elastically deformed, and flexible portions 22 are expanded. As a result, distal end portions 27a of latching arm parts 27 are displaced in the direction away from rotation shaft 13, and distal end portions 27a are disengaged from the lower surfaces of lock projections 15a. That is, the latched state between distal end portions 27a of latching arm parts 27 and concave latching portions 15c is released.

Moreover, pressing portion 25c is separated apart from pressed portion 130c, and plug 120 is released from the state where the entire body thereof is pressed toward the distal end of connector housing 11 by lock member 21.

In such a state, when the operator moves operation portion 25b in the counter-clockwise direction in FIG. 6C-1 by the operator's fingers or the like, lock member 21 is rotated in the counter-clockwise direction about rotation shaft 13, so that latching arm parts 27 are moved upward. With this operation, plug 120 is unlocked.

As described above, since the latched state between distal end portions 27a of latching arm parts 27 and concave latching portions 15c is released by only downwardly pressing bent portions 22a, the lock state of plug 120 can be easily released, and thus, the unlocking properties are extremely improved. Moreover, even when the spring force exerted by latching arm parts 27 is increased in order to improve the lock reliability, since the latched state between distal end portions 27a of latching arm parts 27 and concave latching portions 15c can be released by only downwardly pressing bent portions 22a, distal end portions 27a and concave latching portions 15c are not worn away, and thus, a high durability can be provided.

Moreover, in the present embodiment, a description has been made for the case where the cable is configured as cable 101 having integrated therewith the optical waveguide and conductive wires 151, and the connector is configured as the optical connector having therein optical connection portion 16 and electric connection portion 17. However, the cable may be configured to include only the optical waveguide, and the connector may be configured to include only optical connection portion 16.

In addition, in the present embodiment, a description has been made for the case where convex portion 31 is formed in rear end portion 18a of abutting portion 18 of connector housing 11, and concave portion 131 is formed in front end portion 130a of plug housing 130. However, convex portion 31 may be formed in front end portion 130a of plug housing 130, and concave portion 131 may be formed in rear end portion 18a of abutting portion 18 of connector housing 11. That is, convex portion 31 may be formed in either one of rear end portion 18a of abutting portion 18 of connector housing 11 or front end portion 130a of plug housing 130, and concave portion 131 configured to be engaged with convex portion 31 may be formed in the other one of rear end portion 18a and front end portion 130a.

As described above, in the present embodiment, receptacle connector 1 includes: connector housing 11 configured to mount thereon plug 120 which is connected to cable 101; and lock member 21 which is attached to connector housing 11 in an attitude-changeable state and configured to be capable of locking plug 120, wherein: connector housing 11 is provided with abutting portion 18 which is configured to be engaged with front end portion 130a of plug 120; lock member 21 is provided with detection lever 28 which has at least a portion thereof being positioned in abutting portion 18 when lock member 21 is at an open position thereof; and when front end portion 130a is engaged with abutting portion 18, at least a portion of plug 120 is brought into tight contact with detection lever 28, allowing lock member 21 to start an attitude changing operation of changing an attitude thereof from the open position.

Owing to such a configuration, it is possible to perform the positioning of plug 120 relative to connector housing 11 in an easy and accurate manner. Moreover, the operator is able to recognize the completion of the positioning of plug 120 in an easy manner.

Moreover, receptacle connector 1 has such a configuration that plug 120 is mounted on connector housing 11 so that the lower surface thereof opposes the upper surface of connector housing 11, and that lock member 21 is provided with first pressing portion 24a and second pressing portion 25a which are configured to be capable of pressing the upper surface of plug 120 toward the upper surface of connector housing 11.

Owing to such a configuration, the stable positional relationship between plug 120 and connector housing 11 can be maintained. Furthermore, receptacle connector 1 has such a configuration that lock member 21 continues the attitude changing operation toward the closed position thereof by its own weight after the attitude changing operation from the open position is started. Owing to such a configuration, the operator is able to recognize the completion of the positioning of plug 120 in an easy manner.

Furthermore, receptacle connector 1 has such a configuration that detection lever 28 has at least a portion which is exposed from abutting portion 18 when lock member 21 is at the open position. Owing to such a configuration, when front end portion 130a is engaged with abutting portion 18, detection lever 28 can be brought into tight contact with front end portion 130a.

Furthermore, receptacle connector 1 has such a configuration that lock member 21 includes bent portion 22a and is provided with flexible portion 22, configured to extend or contract in response to a change in an extent of bending of bent portion 22a; latching arm part 27, configured to engage connector housing 11 by the extension/contraction of flexible portion 22; and pressing portion 25c, configured to be capable of pressing plug 120 toward abutting portion 18 in response to the contraction of extendable/contractible portion 22. Owing to such a configuration, it is possible to realize both easy unlocking properties and reliable locking properties, and thus, even when engagement and disengagement of latching arm parts 27 with and from connector housing 11 is repeated, latching arm parts 27 and connector housing 11 might not be worn away, and hence, a high durability is guaranteed.

Furthermore, receptacle connector 1 has such a configuration that either one of front end portion 130a or rear end portion 18a is formed with convex portion 31 which is provided with circular arc-shaped end portion 31a; the other one of front end portion 130a and rear end portion 18a is formed with concave portion 131 which is provided with two oblique side portions 131a being inclined in mutually opposite directions; and when front end portion 130a and abutting portion 18 are engaged with each other, at least a portion of convex portion 31 is inserted into concave portion 131, so that the positioning between connector housing 11 and plug 120 is achieved. Owing to such a configuration, the positioning of plug 120 relative to connector housing 11 can be accurately performed with high precision.

Furthermore, receptacle connector 1 has such a configuration that abutting portion 18 is provided with pair of sidewall portions 18d, and that when front end portion 130a comes to be positioned between pair of sidewall portions 18d, the rough positioning between connector housing 11 and plug 120 is achieved. Owing to such a configuration, the positioning between connector housing 11 and plug 120 can be carried out in an easy manner with high precision by the engagement between convex portion 31 and concave portion 131.

While a preferred embodiment of the Present Application is shown and described, it is envisioned that those skilled in the art may devise various modifications without departing from the spirit and scope of the foregoing Description and the appended claims.

What is claimed is:

1. An optical connector comprising:
a connector housing configured to mount thereon a plug which is connected to a cable having therein an optical waveguide; and
a lock member which is attached to the connector housing in an attitude-changeable state and configured to be capable of locking the plug:
wherein:
the connector housing is provided with an abutting portion which is configured to be engaged with a front portion of the plug;
the lock member is provided with a detection portion which has at least a portion thereof being positioned in the abutting portion when the lock member is at an open position thereof; and
when the front portion is engaged with the abutting portion, at least a portion of the plug is brought into tight contact with the detection portion, allowing the lock member to start an attitude changing operation of changing an attitude thereof from the open position.

2. The optical connector according to claim 1, wherein:
the plug is mounted on the connector housing so that a lower surface thereof opposes an upper surface of the connector housing; and
the lock member is provided with a plug pressing portion configured to be capable of pressing an upper surface of the plug toward an upper surface of the connector housing.

3. The optical connector according to claim 2, wherein the lock member continues the attitude changing operation toward a closed position thereof by its own weight after the attitude changing operation from the open position is started.

4. The optical connector according to claim 3, wherein the detection portion has at least a portion thereof which is exposed from the abutting portion when the lock member is at the open position.

5. The optical connector according to claim 4, wherein the lock member is provided with:
an extendable/contractible portion provided with a bent portion;
a latched portion configured to be engaged with or disengaged from the connector housing by the extension/contraction of the extendable/contractible portion; and
a pressing portion configured to be capable of pressing the plug toward the abutting portion in response to the contraction of the extendable/contractible portion.

6. The optical connector according to claim 5, wherein:
the abutting portion is provided with a pair of sidewall portions; and
when the front portion comes to be positioned between the pair of sidewall portions, the rough positioning between the connector housing and the plug is achieved.

7. The optical connector according to claim 4, wherein:
either one of the front portion or the abutting portion is formed with a convex portion which is provided with a circular arc-shaped end portion;
the other one of the front portion and the abutting portion is formed with a concave portion which is provided with two oblique side portions being inclined in mutually opposite directions; and
when the front portion and the abutting portion are engaged with each other, at least a portion of the convex portion is inserted into the concave portion, so that the positioning between the connector housing and the plug is achieved.

8. The optical connector according to claim 7, wherein:
the abutting portion is provided with a pair of sidewall portions; and
when the front portion comes to be positioned between the pair of sidewall portions, the rough positioning between the connector housing and the plug is achieved.
